(19) United States
(12) Patent Application Publication
(10) Pub. No.: US 2017/0192480 A1
(43) Pub. Date: Jul. 6, 2017

(54) METHOD FOR ADJUSTING FREQUENCY MODULATION PARAMETERS AND ELECTRONIC DEVICE

(71) Applicants: LE HOLDINGS (BEIJING) CO., LTD., ChaoYang District (CN); LEMOBILE INFORMATION TECHNOLOGY (BEIJING) CO., LTD., ChaoYang District (CN)

(72) Inventors: Shufeng Ren, ChaoYang District (CN); Guofeng Xie, ChaoYang District (CN)

(21) Appl. No.: 15/242,440

(22) Filed: Aug. 19, 2016

Related U.S. Application Data
(63) Continuation of application No. PCT/CN2016/088731, filed on Jul. 5, 2016.

(30) Foreign Application Priority Data
Dec. 31, 2015 (CN) 2015110309529

(51) Int. Cl. G06F 1/32; H04W 52/02; H04L 12/26

(52) U.S. Cl. CPC G06F 1/324; H04L 43/16; H04W 52/0209; H04W 88/02

(57) ABSTRACT

Disclosed are a method for adjusting frequency modulation parameters and electronic devices, a frequency modulator and a mobile terminal. The method includes: acquiring a normalized value generated correspondingly by a CPU running preset codes, in a case that a frequency of the CPU is modulated in a governor frequency modulation mode; judging whether the normalized value is greater than a preset normalized threshold value, wherein the preset normalized threshold value is a normalized value generated correspondingly by the CPU running the preset codes in a frequency required to maintain a mobile terminal to operate with basic performances; and adjusting frequency modulation parameters in the governor frequency modulation mode, to control the normalized value to approach the preset normalized threshold value, to adjust power consumption of the CPU, in a case that the normalized value is greater than the preset normalized threshold value.

### CROSS REFERENCE TO RELATED APPLICATIONS

The present application is a continuation of PCT application which has an application number of PCT/CN2016/088731 and was filed on Jul. 5, 2016. This application is based upon and claims priority to Chinese Patent Application NO. 2015110309529, titled “method and apparatus for adjusting frequency modulation parameters, frequency modulator and mobile terminal”, filed Dec. 31, 2015, the entire content of which is incorporated herein by reference.

### TECHNICAL FIELD

The disclosure relates to the technical field of terminals, and in particular to a method for adjusting frequency modulation parameters and electronic device.

### BACKGROUND

With the development of electronic technology, more and more intelligent terminals are emerged, such as a computer, a smart TV and a mobile terminal. The intelligent mobile terminal is an intelligent electronic device which is used most widely.

A central processing unit (CPU) is arranged in all existing mobile terminal to process service to be processed in the terminal. With an increasing demand of a user for high performance of the mobile terminal, a frequency of the CPU in the mobile terminal is increased unceasingly, the number of cores of the CPU is more and more, and thus the performance of the terminal is enhanced increasingly and the performance is gradually excessed.

However, in a process of implementing the present disclosure, the inventor has found that battery life of the mobile terminal does not catch up with the improvement of the CPU of the mobile terminal, and the battery life of the mobile terminal becomes worse with the upgrading of the software in the prior art.

### SUMMARY

In view of aforesaid problems, the disclosure is put forward to provide a method for adjusting frequency modulation parameters and electronic device.

A method for adjusting frequency modulation parameters is provided according to an embodiment of the disclosure, which includes:

acquiring a normalized value generated correspondingly by a central processing unit running preset codes, in a case that a frequency of the central processing unit is modulated in a governor frequency modulation mode;

judging whether the normalized value is greater than a preset normalized threshold value, wherein the preset normalized threshold value is a normalized value generated correspondingly by the central processing unit running the preset codes in a frequency required to maintain a mobile terminal to operate with basic performances; and

adjusting frequency modulation parameters in the governor frequency modulation mode, so as to control the normalized value to approach the preset normalized threshold value, to adjust power consumption of the central processing unit, in a case that the normalized value is greater than the preset normalized threshold value.

An electronic device is further provided according to an embodiment of the disclosure, which includes:

at least one processor; and

a memory communicably connected with the at least one processor for storing instructions executable by the at least one processor, wherein execution of the instructions by the at least one processor causes the at least one processor to:

acquiring a normalized value generated correspondingly by a central processing unit running preset codes, in a case that a frequency of the central processing unit is modulated in a governor frequency modulation mode;

judging whether the normalized value is greater than a preset normalized threshold value, wherein the preset normalized threshold value is a normalized value generated correspondingly by the central processing unit running the preset codes in a frequency required to maintain a mobile terminal to operate with basic performances; and

adjusting frequency modulation parameters in the governor frequency modulation mode, so as to control the normalized value to approach the preset normalized threshold value, to adjust power consumption of the central processing unit, in a case that the normalized value is greater than the preset normalized threshold value.

A non-transitory computer-readable storage medium is further provided according to the disclosure, and the non-transitory computer-readable storage medium storing executable instructions that, when executed by an electronic device with a touch-sensitive display, cause the electronic device to:

acquiring a normalized value generated correspondingly by a central processing unit running preset codes, in a case that a frequency of the central processing unit is modulated in a governor frequency modulation mode;

judging whether the normalized value is greater than a preset normalized threshold value, wherein the preset normalized threshold value is a normalized value generated correspondingly by the central processing unit running the preset codes in a frequency required to maintain a mobile terminal to operate with basic performances; and

adjusting frequency modulation parameters in the governor frequency modulation mode, so as to control the normalized value to approach the preset normalized threshold value, to adjust power consumption of the central processing unit, in a case that the normalized value is greater than the preset normalized threshold value.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for adjusting frequency modulation parameters in accordance with some embodiments.

FIG. 2 is a flow chart of a method for adjusting frequency modulation parameters in accordance with some embodiments.

FIG. 3 is a flow chart of a method for adjusting frequency modulation parameters in accordance with some embodiments.

FIG. 4 is a schematic structural diagram of an apparatus for adjusting frequency modulation parameters in accordance with some embodiments.

FIG. 5 is a schematic structural diagram of an apparatus for adjusting frequency modulation parameters in accordance with some embodiments.

FIG. 6 illustrates a block diagram of an electronic device according to the present disclosure.

### DETAILED DESCRIPTION

The disclosure is described in further detail with reference to the drawings and embodiments below. Although the drawings show exemplary embodiments of the disclosure, it should be understood that the disclosure may be implemented in various forms but should not be limit to the embodiments set forth herein. On the contrary, these embodiments contribute to a more thorough understanding of the disclosure, and can completely convey the scope of the disclosure to those skilled in the art.

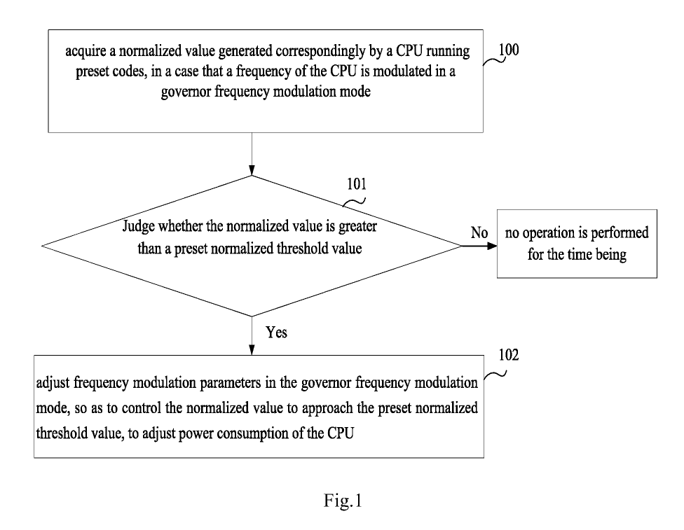

FIG. 1 is a flow chart of a method for adjusting frequency modulation parameters in accordance with a first embodiment. As shown in FIG. 1, the method for adjusting frequency modulation parameters in accordance with the embodiment may include specifically the following steps 100 to 102.

In step 100, a normalized value generated correspondingly by a CPU running preset codes is acquired, in a case that a frequency of the CPU is modulated in a governor frequency modulation mode.

First, the preset codes in this embodiment are a piece of complex program, which includes operations such as addition, subtraction, multiplication, division, and, or, non. After the piece of complex program is started for a time duration (assumed that the time duration is Time), the CPU is at a maximum frequency. That is, the frequency of the CPU can dynamically change until the frequency of the CPU is stably at the maximum frequency and high intensity computation is performed, after the preset codes are ran, in a case that the frequency of the CPU is modulated in the governor frequency modulation mode. The efficiency of the governor frequency modulation mode can be determined based on only a time consumed for high intensity computation. In this embodiment, the normalized value generated correspondingly by a CPU running preset codes is a normalized value in this condition.

In step 101, it is judged whether the normalized value is greater than a preset normalized threshold value; step 102 is performed, if the normalized value is greater than the preset normalized threshold value; no operation is performed for the time being, if the normalized value is equal to the preset normalized threshold value.

In this embodiment, the preset normalized threshold value is a normalized value generated correspondingly by the central processing unit running the preset codes in a frequency required to maintain a mobile terminal to operate with basic performances. That is, the preset normalized threshold value is a value to ensure the mobile terminal to operate with the basic performances. The degree of the user experience can be ensured and the basic use of the mobile terminal by the user is not influenced, as long as the preset normalized threshold value can be ensured.

In a case that the normalized value is equal to the preset normalized threshold value, it represents that the CPU has a minimum performance, and only the basic function of the mobile terminal is ensured, that is, the mobile terminal is currently at lowest power consumption and most energy saving state without influencing the user experience. In this embodiment, a case that the normalized value is less than the preset normalized threshold value does not exist, that is because the preset normalized value is a minimum normalized threshold value without influencing the user experience, and an even lower normalized threshold value without influencing the user experience is impossible.

In step 102, frequency modulation parameters in the governor frequency modulation mode are adjusted to control the normalized value to approach the preset normalized threshold value, to adjust power consumption of the CPU.

Since the preset normalized value is a normalized threshold value corresponding to the lowest power consumption and most energy saving state without influencing the user experience of the mobile terminal in this embodiment, if the normalized value is greater than a preset normalized threshold value, it represents that the operating state of the mobile terminal may be adjusted to reach the lowest power consumption and most energy saving state without influencing the user experience. In this embodiment, the frequency modulation parameters of the frequency modulator for adjusting the frequency of the CPU in the mobile terminal in the governor frequency modulation mode are adjusted to control the normalized value to approach the preset normalized threshold value, to adjust power consumption of the CPU. Therefore, the CPU has lowest power consumption and most energy saving on the premise that user experience is not influenced, and thus the battery life of the mobile terminal is enhanced effectively.

With the method for adjusting frequency modulation parameters according to the embodiment, the normalized value generated correspondingly by the CPU running the preset codes is acquired in a case that a frequency of the CPU is modulated in a governor frequency modulation mode, and it is judged whether the normalized value is greater than a preset normalized threshold value; and in a case that the normalized value is greater than the preset normalized threshold value, the frequency modulation parameters in the governor frequency modulation mode are adjusted to control the normalized value to approach the preset normalized threshold value, to adjust power consumption of the CPU. Thus, the CPU has lowest power consumption and most energy saving on the premise that user experience is not influenced. In the solution of adjusting frequency modulation parameters according to the embodiment, the frequency modulation parameters of the frequency modulator in the mobile terminal in the governor frequency modulation mode are adjusted, the performance of the CPU in the mobile terminal may be in an optimal condition without influencing the user experience, and it can ensured that the CPU of the mobile terminal has lowest power consumption and most energy saving. Therefore, the battery life of a battery in the mobile terminal can be enhanced effectively. By verifying the solution in this embodiment with Linux kernel or a governor frequency modulation mode of the CPU provided by google, it can be found that at least five percent of the average battery life is added for the battery in the mobile terminal by adopting the solution in this embodiment.

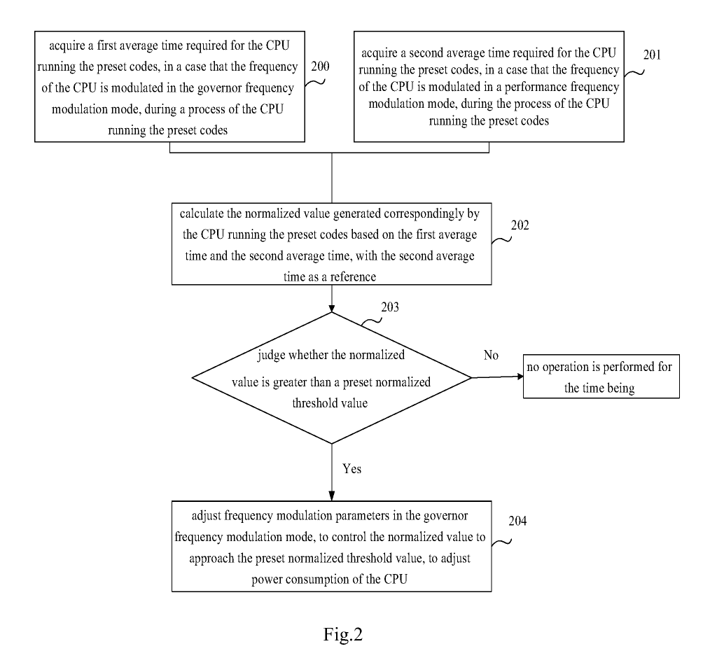

FIG. 2 is a flow chart of a method for adjusting frequency modulation parameters in accordance with a second embodiment. As shown in FIG. 2, a technical solution of the disclosure is described by taking a CPU with a single core as an example in the method for adjusting frequency modulation parameters in accordance with the embodiment, on the base of the technical solution in the above embodiment shown in FIG. 1. As shown in FIG. 2, the method for adjusting frequency modulation parameters in accordance with the embodiment may include specifically the following steps 200 to 204.

In step 200, a first average time required for the CPU running the preset codes is acquired, in a case that the frequency of the CPU is modulated in the governor frequency modulation mode, during a process of the CPU running the preset codes.

In this embodiment, the CPU may run the preset codes several times, in a case that the frequency of the CPU is modulated in the governor frequency modulation mode, during the process of the CPU running the preset codes. For example, depending on an actual application scenario, the CPU may run the preset codes 20 or 30 times, then a total time for running the preset codes several times is recorded, and an average time for the CPU running the preset codes each time is obtained by dividing the total time by the total times, that is, the first average time. In this embodiment, in order to ensure the accuracy of the first average time, the CPU is controlled to run the preset codes several times to obtain a more accurate value. The preset times may be specifically set to be other values as actual needed, which is not limited herein.

In step 201, a second average time required for the CPU running the preset codes is acquired, in a case that the frequency of the CPU is modulated in a performance frequency modulation mode, during the process of the CPU running the preset codes.

In this embodiment, the performance frequency modulation mode specifically includes adjusting the frequency of the CPU to be a maximum frequency. Similarly, the CPU may run the preset codes preset times in the maximum frequency to obtain a more accurate second average time, specifically, the preset times may be 20 or 30 times, in this embodiment.

In addition, step 200 and step 201 may be not limited in order in this embodiment.

In step 202, the normalized value generated correspondingly by the CPU running the preset codes is calculated based on the first average time and the second average time, with the second average time as a reference.

Specifically, the normalized value generated correspondingly by the CPU running the preset codes may be expressed as the following formula: X×100/Y, where X represents the first average time and Y represents the second average time. The entirety is normalized to be 100, and thus the X/Y is multiplied by 100.

Steps 200 to 202 in this embodiment is a specific implementation way of step 100 in the above embodiment shown in FIG. 1.

In step 203, it is judged whether the normalized value is greater than a preset normalized threshold value; step 204 is performed, if the normalized value is greater than the preset normalized threshold value; no operation is performed for the time being, if the normalized value is equal to the preset normalized threshold value.

Specifically, before step 203, the method may further include calculating a preset normalized threshold value. The specific calculation of the preset normalized threshold value (can be expressed as N) is similar to the process of acquiring a normalized value described above, which may be specifically implemented in the following way. The governor frequency modulation mode is turned off, a minimum frequency to maintain the mobile terminal to operate with basic performances is acquired, the CPU is controlled to run the preset codes preset times C1 in the frequency, a total time T1 for the CPU running the preset codes the preset times is recorded, and an average time X1 for the CPU running the preset codes in the frequency is obtained by dividing the total time T1 by the total times C1, that is, X1=T1/C1. Then, the CPU is controlled to run the preset codes preset times C2 in the performance frequency modulation mode, that is, the CPU is controlled to run the preset codes the preset times C2 in the maximum frequency, in this case, a total time T2 for the CPU running the preset codes the preset times in this frequency is recorded, and an average time Y1 for the CPU running the preset codes in the frequency is obtained by dividing the total time T2 by the total times C2, that is, Y1=T2/C2. Finally, the preset normalized threshold value N may be calculated according to the formula N=X1×100/Y1.

In step 204, frequency modulation parameters in the governor frequency modulation mode are adjusted to control the normalized value to approach the preset normalized threshold value, to adjust power consumption of the CPU.

For example, in this embodiment, the adjusting frequency modulation parameters in the governor frequency modulation mode specifically includes at least one of the following:

adjusting a sampling period in the governor frequency modulation mode;

adjusting a threshold for increasing a frequency in the governor frequency modulation mode;

adjusting a threshold for reducing a frequency in the governor frequency modulation mode;

adjusting a response whether the central processing unit suffers a sudden large load; and

adjusting a duration for the central processing unit being at a maximum frequency.

It should be noted that the frequency modulation parameters in the governor frequency modulation mode are not just limited to the above listed several parameters, and similar other frequency modulation parameters may also be included in practical applications, which are not repeated one by one any more herein. For other specific implementation ways for step 203 and step 204 in this embodiment, reference may be made to the description of step 101 and step 102 in the above embodiment shown in FIG. 1, which is not repeated any more herein.

With the method for adjusting frequency modulation parameters according to the embodiment, the frequency modulation parameters in the governor frequency modulation mode are adjusted using the above-described solution, so that the normalized value can approach the preset normalized threshold value, to adjust power consumption of the CPU. Thus, the CPU has lowest power consumption and most energy saving on the premise that user experience is not influenced. In the solution of adjusting frequency modulation parameters according to the embodiment, the frequency modulation parameters of the frequency modulator in the mobile terminal in the governor frequency modulation mode are adjusted, the performance of the CPU in the mobile terminal may be in an optimal condition without influencing the user experience, and it can ensured that the CPU of the mobile terminal has lowest power consumption and most energy saving. Therefore, the battery life of the battery in the mobile terminal can be enhanced effectively.

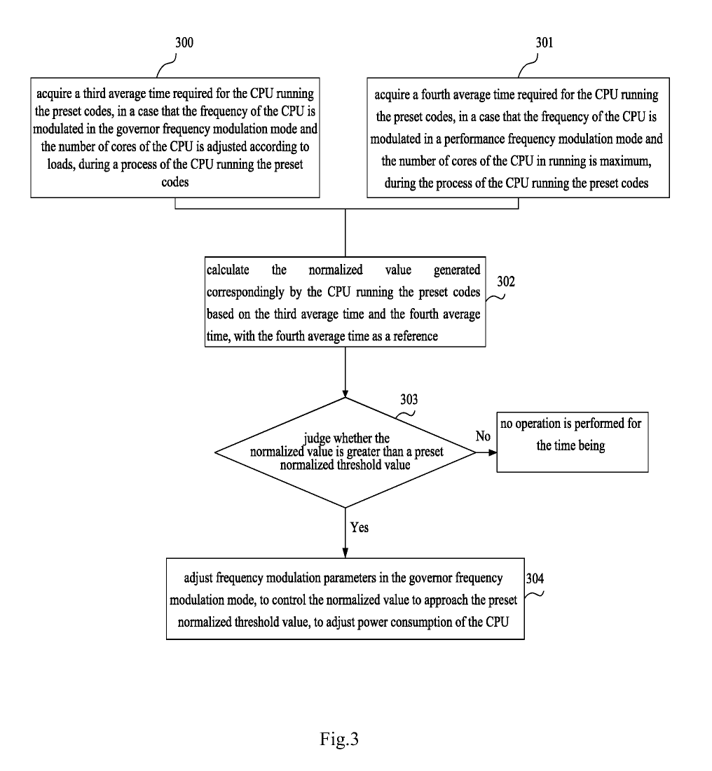

FIG. 3 is a flow chart of a method for adjusting frequency modulation parameters in accordance with a third embodiment. As shown in FIG. 3, a technical solution of the disclosure is described by taking a CPU with multiple cores as an example in the method for adjusting frequency modulation parameters in accordance with the embodiment, on the base of the technical solution in the above embodiment shown in FIG. 1. As shown in FIG. 3, the method for adjusting frequency modulation parameters in accordance with the embodiment may include specifically the following steps 300 to 304.

In step 300, a third average time required for the CPU running the preset codes is acquired, in a case that the frequency of the CPU is modulated in the governor frequency modulation mode and the number of cores of the CPU is adjusted according to loads, during a process of the CPU running the preset codes.

This step differs from step 200 in the above embodiment shown in FIG. 2 in that, the step of adjusting the number of cores of the CPU according to loads is added during the process of the CPU running the preset codes, the number of cores of the CPU is utilized fully and reasonably to play the best performance of the CPU. For other contents, reference is made to the description of step 200 in the above embodiment shown in FIG. 2, which is not repeated any more.

In step 301, a fourth average time required for the CPU running the preset codes is acquired, in a case that the frequency of the CPU is modulated in a performance frequency modulation mode and the number of cores of the CPU in running is maximum, during the process of the CPU running the preset codes.

This step differs from step 201 in the above embodiment shown in FIG. 2 in that, the number of cores of the CPU in running is controlled to be maximum, and the case of the CPU running the preset codes at the best performance status is tested during the process of the CPU running the preset codes in this step. For other contents, reference is made to the description of step 201 in the above embodiment shown in FIG. 2, which is not repeated any more.

Similarly, step 300 and step 301 are not limited in order.

In step 302, the normalized value generated correspondingly by the CPU running the preset codes is calculated based on the third average time and the fourth average time, with the fourth average time as a reference.

The specific implementation way of this step is the same as the specific implementation way of step 202 in the above embodiment shown in FIG. 2, and reference may be made to the related description in the above embodiment for details, which is not repeated any more.

Steps 300 to 302 in this embodiment is a specific implementation way of step 100 in the above embodiment shown in FIG. 1.

In step 303, it is judged whether the normalized value is greater than a preset normalized threshold value; step 304 is performed, if the normalized value is greater than the preset normalized threshold value; no operation is performed for the time being, if the normalized value is equal to the preset normalized threshold value.

In step 304, frequency modulation parameters in the governor frequency modulation mode are adjusted to control the normalized value to approach the preset normalized threshold value, to adjust power consumption of the CPU.

For step 303 and step 304 in this embodiment, reference may be made to the specific implementation ways of step 203 and step 204 in the above embodiment shown in FIG. 2, and reference may be made to the related description of the above embodiment for details, which is not repeated any more herein.

With the method for adjusting frequency modulation parameters according to the embodiment, the frequency modulation parameters in the governor frequency modulation mode are adjusted using the above-described solution, so that the normalized value can approach the preset normalized threshold value, to adjust power consumption of the CPU. Thus, the CPU has lowest power consumption and most energy saving on the premise that user experience is not influenced. In the solution of adjusting frequency modulation parameters according to the embodiment, the frequency modulation parameters of the frequency modulator in the mobile terminal in the governor frequency modulation mode are adjusted, the performance of the CPU in the mobile terminal may be in an optimal condition without influencing the user experience, and it can ensured that the CPU of the mobile terminal has lowest power consumption and most energy saving. Therefore, the battery life of the battery in the mobile terminal can be enhanced effectively.

FIG. 4 a schematic structural diagram of an apparatus for adjusting frequency modulation parameters in accordance with a first embodiment. As shown in FIG. 4, the apparatus for adjusting frequency modulation parameters in accordance with the embodiment may include specifically: an acquiring module 10, a judging module 11 and an adjusting module 12.

The acquiring module 10 is adapted to acquire a normalized value generated correspondingly by a CPU running preset codes, in a case that a frequency of the CPU is modulated in a governor frequency modulation mode; the judging module 11 is adapted to judge whether the normalized value is greater than a preset normalized threshold value, where the preset normalized threshold value is a normalized value generated correspondingly by the CPU running the preset codes in a frequency required to maintain a mobile terminal to operate with basic performances; and the adjusting module 12 is adapted to adjust frequency modulation parameters in the governor frequency modulation mode, to control the normalized value to approach the preset normalized threshold value, to adjust power consumption of the CPU, in a case that the normalized value is greater than the preset normalized threshold value.

For the apparatus for adjusting frequency modulation parameters in accordance with the embodiment, the method for adjusting frequency modulation parameters is implemented by using the above-described modules and the effect is the same as that described in the above embodiments shown in FIG. 1 are realized by using the above-described modules, reference may be made to the description of the above embodiment shown in FIG. 1 for details, which is not repeated any more.

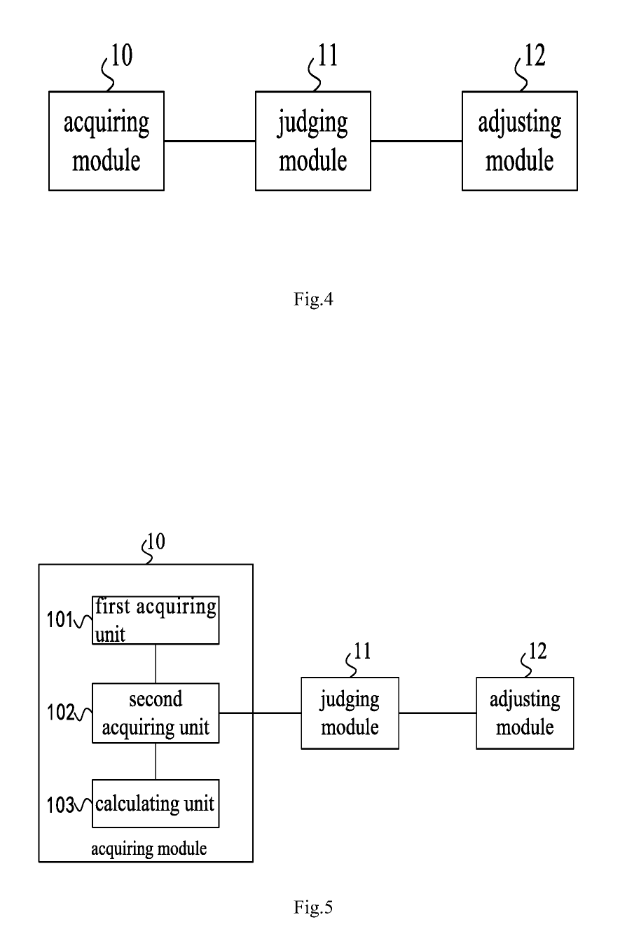

FIG. 5 is a schematic structural diagram of an apparatus for adjusting frequency modulation parameters in accordance with a second embodiment. As shown in FIG. 5, the apparatus for adjusting frequency modulation parameters in accordance with the embodiment may further describe a technical solution of the disclosure in more details, on the base of the technical solution in the above embodiment as shown in FIG. 4.

As shown in FIG. 5, in the apparatus for adjusting frequency modulation parameters in accordance with the embodiment, the acquiring module 10 may include specifically: a first acquiring unit 101, a second acquiring unit 102 and a calculating unit 103.

The first acquiring unit 101 is adapted to acquire a first average time required for the CPU running the preset codes, in a case that the frequency of the CPU is modulated in the governor frequency modulation mode, during a process of the CPU running the preset codes, in a case that the CPU has a single core design; the second acquiring unit 102 is adapted to acquire a second average time required for the CPU running the preset codes, in a case that the frequency of the CPU is modulated in a performance frequency modulation mode, during the process of the CPU running the preset codes, in a case that the CPU has the single core design; and the calculating unit 103 is adapted to calculate the normalized value generated correspondingly by the CPU running the preset codes based on the first average time and the second average time, with the second average time as a reference. In this case, the judging module 11 is connected to the calculating unit 103, and the judging module 11 is used to judge whether the normalized value calculated by the calculating unit 103 is greater than the preset normalized threshold value.

Alternatively, in the apparatus for adjusting frequency modulation parameters in accordance with the embodiment, the first acquiring unit 101 is further adapted to acquire a third average time required for the CPU running the preset codes, in a case that the frequency of the CPU is modulated in the governor frequency modulation mode and the number of cores of the CPU is adjusted according to loads, during a process of the CPU running the preset codes, in a case that the CPU has a multi-core design; the second acquiring unit 102 is further adapted to acquire a fourth average time required for the CPU running the preset codes, in a case that the frequency of the CPU is modulated in a performance frequency modulation mode and the number of cores of the CPU in running is maximum, during the process of the CPU running the preset codes, in a case that the CPU has the multi-core design; and the calculating unit 103 is adapted to calculate the normalized value generated correspondingly by the CPU running the preset codes based on the third average time and the fourth average time, with the fourth average time as a reference.

Further, optionally, in the apparatus for adjusting frequency modulation parameters in accordance with the embodiment, the adjusting module 12 is specifically adapted to perform at least one of the following operations, in a case that the normalized value is greater than the preset normalized threshold value:

adjusting a sampling period in the governor frequency modulation mode;

adjusting a threshold for increasing a frequency in the governor frequency modulation mode;

adjusting a threshold for reducing a frequency in the governor frequency modulation mode;

adjusting a response whether the central processing unit suffers a sudden large load; and

adjusting a duration for the central processing unit being at a maximum frequency.

For the apparatus for adjusting frequency modulation parameters in accordance with the embodiment, the method for adjusting frequency modulation parameters is implemented by using the above-described modules and the effect is the same as that described in the above embodiments shown in FIG. 2 or FIG. 3, reference may be made to the description of the above embodiment shown in FIG. 2 or FIG. 3 for details, which are not repeated any more.

A frequency modulator is further provided according to an embodiment of the disclosure, and the apparatus for adjusting frequency modulation parameters as shown in FIG. 4 or FIG. 5 is arranged in the frequency modulator in the embodiment. In this embodiment, the apparatus for adjusting frequency modulation parameters is arranged in the frequency modulator for modulating a frequency of the CPU as an example. For the detailed structure of the apparatus for adjusting frequency modulation parameters, reference may be made to the description of the above embodiments shown in FIG. 4 or FIG. 5, and for specific implementation ways, reference may be made to the description of any one of the above embodiments shown in FIG. 1 to FIG. 3, which are not repeated any more.

A mobile terminal is further provided according to an embodiment of the disclosure. In this embodiment, the frequency modulator according to the above embodiment is arranged on the mobile terminal, and reference may be made to the description of the above embodiment for the frequency modulator for details.

A mobile terminal may be further provided according to another embodiment of the disclosure. In this embodiment, the apparatus for adjusting frequency modulation parameters according to the above embodiments as shown in FIG. 4 or FIG. 5 and the frequency modulator are arranged on the mobile terminal, the frequency modulator is capable of operate in the governor frequency modulation mode, and the apparatus for adjusting frequency modulation parameters is configured to adjust frequency modulation parameters of the frequency modulator in the governor frequency modulation mode. In this embodiment, the apparatus for adjusting frequency modulation parameters may be independent of the frequency modulator, that is, the apparatus for adjusting frequency modulation parameters may be not arranged in the frequency modulator. Similarly, for the detailed structure of the apparatus for adjusting frequency modulation parameters, reference may be made to the description of the above embodiments shown in FIG. 4 or FIG. 5, and for specific implementation ways, reference may be made to the description of any one of the above embodiments shown in FIG. 1 to FIG. 3, which are not repeated any more.

Further, an embodiment of the present disclosure further provides a non-transitory computer-readable storage medium storing executable instructions, which can be executed by an electronic device to perform any methods for adjusting frequency modulation parameters mentioned by embodiments of the present disclosure.

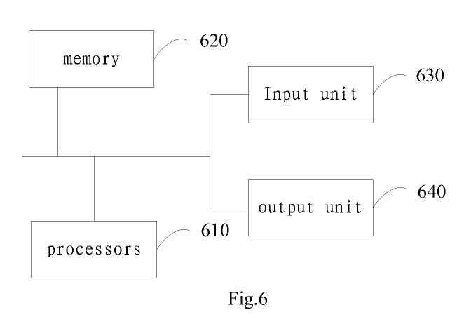

Further, an embodiment of the present disclosure further provides an electronic device, FIG. 6 is a block diagram of an electronic device which is configured to perform the methods for adjusting frequency modulation parameters according to an embodiment of the present disclosure. As shown in FIG. 6, the device includes: one or more processors 610 and memory 620. A processor 610 is showed in FIG. 6 for an example.

Device which is configured to perform the methods for adjusting frequency modulation parameters can also include: input unit 630 and output unit 640.

Processor 610, memory 620, input unit 630 and output unit 640 can be connected by BUS or other methods, and BUS connecting is showed in FIG. 6 for an example.

Memory 610 can be used for storing non-transitory software program, non-transitory computer executable program and modules as a non-transitory computer-readable storage medium, such as corresponding program instructions/modules for the methods for adjusting frequency modulation parameters mentioned by embodiments of the present disclosure (such as shown in FIG. 4, acquiring module 10, judging module 20, adjusting module 30). Processor 610 performs kinds of functions and adjusting frequency modulation parameters of the electronic device by executing non-transitory software program, instructions and modules which are stored in memory 620, thereby realizes the methods for adjusting frequency modulation parameters mentioned by embodiments of the present disclosure.

Memory 610 can include program storage area and data storage area, thereby the operating system and applications required by at least one function can be stored in program storage area and data created by using the device for adjusting frequency modulation parameters can be stored in data storage area. Furthermore, memory 620 can include high speed Random-access memory (RAM) or non-volatile memory such as magnetic disk storage device, flash memory device or other non-volatile solid state storage devices. In some embodiments, memory 610 can include long-distance setup memories relative to processor 620, which can communicate with the device for adjusting frequency modulation parameters by networks. The examples of said networks are including but not limited to Internet, Intranet, LAN, mobile Internet and their combinations.

Input unit 630 can be used to receive inputted number, character information and key signals causing user configures and function controls of the device for adjusting frequency modulation parameters. Output unit 640 can include a display screen or a display device.

The said module or modules are stored in memory 620 and perform the methods for adjusting frequency modulation parameters when executed by one or more processors 610.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-10. (canceled)

11. A method for adjusting frequency modulation parameters, applied to electronic devices, the method comprising:
acquiring a normalized value generated correspondingly by a central processing unit running preset codes, in a case that a frequency of the central processing unit is modulated in a governor frequency modulation mode;
judging whether the normalized value is greater than a preset normalized threshold value, wherein the preset normalized threshold value is a normalized value generated correspondingly by the central processing unit running the preset codes in a frequency required to maintain a mobile terminal to operate with basic performances; and
adjusting frequency modulation parameters in the governor frequency modulation mode, so as to control the normalized value to approach the preset normalized threshold value, to adjust power consumption of the central processing unit, in a case that the normalized value is greater than the preset normalized threshold value.

12. The method according to claim 11, wherein in a case that the central processing unit has a single core design, the acquiring a normalized value generated correspondingly by a central processing unit running preset codes, in a case that a frequency of the central processing unit is modulated in a governor frequency modulation mode further comprises:
acquiring a first average time required for the central processing unit running the preset codes, during a process of the central processing unit running the preset codes, in a case that the frequency of the central processing unit is modulated in the governor frequency modulation mode;
acquiring a second average time required for the central processing unit running the preset codes, during the process of the central processing unit running the preset codes, in a case that the frequency of the central processing unit is modulated in a performance frequency modulation mode; and
calculating the normalized value generated correspondingly by the central processing unit running the preset codes based on the first average time and the second average time, with the second average time as a reference.

13. The method according to claim 11, wherein in a case that the central processing unit has a multi-core design, the acquiring a normalized value generated correspondingly by a central processing unit running preset codes, in a case that a frequency of the central processing unit is modulated in a governor frequency modulation mode further comprises:
acquiring a third average time required for the central processing unit running the preset codes, during a process of the central processing unit running the preset codes, in a case that the frequency of the central processing unit is modulated in the governor frequency modulation mode and the number of cores of the central processing unit is adjusted according to loads;
acquiring a fourth average time required for the central processing unit running the preset codes, during the process of the central processing unit running the preset codes, in a case that the frequency of the central processing unit is modulated in a performance frequency modulation mode and the number of cores of the central processing unit in running is maximum; and
calculating the normalized value generated correspondingly by the central processing unit running the preset codes based on the third average time and the fourth average time, with the fourth average time as a reference.

14. The method according to claim 12, wherein the adjusting frequency modulation parameters in the governor frequency modulation mode comprises at least one of the following:
adjusting a sampling period in the governor frequency modulation mode;
adjusting a threshold for increasing a frequency in the governor frequency modulation mode;
adjusting a threshold for reducing a frequency in the governor frequency modulation mode;
adjusting a response whether the central processing unit suffers a sudden large load; and
adjusting a duration for the central processing unit being at a maximum frequency.

15. The method according to claim 13, wherein the adjusting frequency modulation parameters in the governor frequency modulation mode comprises at least one of the following:
adjusting a sampling period in the governor frequency modulation mode;
adjusting a threshold for increasing a frequency in the governor frequency modulation mode;
adjusting a threshold for reducing a frequency in the governor frequency modulation mode;
adjusting a response whether the central processing unit suffers a sudden large load; and
adjusting a duration for the central processing unit being at a maximum frequency.

16. An electronic device, comprising:
at least one processor; and
a memory communicably connected with the at least one processor for storing instructions executable by the at least one processor, wherein execution of the instructions by the at least one processor causes the at least one processor to:
acquire a normalized value generated correspondingly by a central processing unit running preset codes, in a case that a frequency of the central processing unit is modulated in a governor frequency modulation mode;
judge whether the normalized value is greater than a preset normalized threshold value, wherein the preset normalized threshold value is a normalized value generated correspondingly by the central processing unit running the preset codes in a frequency required to maintain a mobile terminal to operate with basic performances; and
adjust frequency modulation parameters in the governor frequency modulation mode, so as to control the normalized value to approach the preset normalized threshold value, to adjust power consumption of the central processing unit, in a case that the normalized value is greater than the preset normalized threshold value.

17. The electronic device according to claim 16, wherein execution of the instructions by the at least one processor causes the at least one processor further to:
in a case that the central processing unit has a single core design, acquire a first average time required for the central processing unit running the preset codes, during a process of the central processing unit running the preset codes, in a case that the frequency of the central processing unit is modulated in the governor frequency modulation mode;
acquire a second average time required for the central processing unit running the preset codes, during the process of the central processing unit running the preset codes, in a case that the frequency of the central processing unit is modulated in a performance frequency modulation mode; and
calculate the normalized value generated correspondingly by the central processing unit running the preset codes based on the first average time and the second average time, with the second average time as a reference.

18. The electronic device according to claim 16, wherein execution of the instructions by the at least one processor causes the at least one processor further to:
in a case that the central processing unit has a multi-core design,
acquire a third average time required for the central processing unit running the preset codes, during a process of the central processing unit running the preset codes, in a case that the frequency of the central processing unit is modulated in the governor frequency modulation mode and the number of cores of the central processing unit is adjusted according to loads;
acquire a fourth average time required for the central processing unit running the preset codes, during the process of the central processing unit running the preset codes, in a case that the frequency of the central processing unit is modulated in a performance frequency modulation mode and the number of cores of the central processing unit in running is maximum; and
calculate the normalized value generated correspondingly by the central processing unit running the preset codes based on the third average time and the fourth average time, with the fourth average time as a reference.

19. The electronic device according to claim 17, wherein execution of the instructions by the at least one processor causes the at least one processor further to:
perform at least one of the following operations in a case that the normalized value is greater than the preset normalized threshold value:
adjust a sampling period in the governor frequency modulation mode;
adjust a threshold for increasing a frequency in the governor frequency modulation mode;
adjust a threshold for reducing a frequency in the governor frequency modulation mode;
adjust a response whether the central processing unit suffers a sudden large load; and
adjust a duration for the central processing unit being at a maximum frequency.

20. The electronic device according to claim 18, wherein execution of the instructions by the at least one processor causes the at least one processor further to:
perform at least one of the following operations in a case that the normalized value is greater than the preset normalized threshold value:
adjust a sampling period in the governor frequency modulation mode;
adjust a threshold for increasing a frequency in the governor frequency modulation mode;
adjust a threshold for reducing a frequency in the governor frequency modulation mode;
adjust a response whether the central processing unit suffers a sudden large load; and
adjust a duration for the central processing unit being at a maximum frequency.

21. A non-transitory computer-readable storage medium storing executable instructions that, when executed by an electronic device with a touch-sensitive display, cause the electronic device to:
acquire a normalized value generated correspondingly by a central processing unit running preset codes, in a case that a frequency of the central processing unit is modulated in a governor frequency modulation mode;
judge whether the normalized value is greater than a preset normalized threshold value, wherein the preset normalized threshold value is a normalized value generated correspondingly by the central processing unit running the preset codes in a frequency required to maintain a mobile terminal to operate with basic performances; and
adjust frequency modulation parameters in the governor frequency modulation mode, so as to control the normalized value to approach the preset normalized threshold value, to adjust power consumption of the central processing unit, in a case that the normalized value is greater than the preset normalized threshold value.

22. The non-transitory computer-readable storage medium according to claim 21, wherein the executable instructions, when executed by an electronic device with a touch-sensitive display, cause the electronic device further to:
in a case that the central processing unit has a single core design, acquire a first average time required for the central processing unit running the preset codes, during a process of the central processing unit running the preset codes, in a case that the frequency of the central processing unit is modulated in the governor frequency modulation mode;
acquire a second average time required for the central processing unit running the preset codes, during the process of the central processing unit running the preset codes, in a case that the frequency of the central processing unit is modulated in a performance frequency modulation mode; and
calculate the normalized value generated correspondingly by the central processing unit running the preset codes based on the first average time and the second average time, with the second average time as a reference.

23. The non-transitory computer-readable storage medium according to claim 21, wherein the executable instructions, when executed by an electronic device with a touch-sensitive display, cause the electronic device further to:
in a case that the central processing unit has a multi-core design,
acquire a third average time required for the central processing unit running the preset codes, during a process of the central processing unit running the preset codes, in a case that the frequency of the central processing unit is modulated in the governor frequency modulation mode and the number of cores of the central processing unit is adjusted according to loads;
acquire a fourth average time required for the central processing unit running the preset codes, during the process of the central processing unit running the preset codes, in a case that the frequency of the central processing unit is modulated in a performance frequency modulation mode and the number of cores of the central processing unit in running is maximum; and
calculate the normalized value generated correspondingly by the central processing unit running the preset codes based on the third average time and the fourth average time, with the fourth average time as a reference.

24. The non-transitory computer-readable storage medium according to claim 22, wherein the executable instructions, when executed by an electronic device with a touch-sensitive display, cause the electronic device further to:
perform at least one of the following operations in a case that the normalized value is greater than the preset normalized threshold value:
adjust a sampling period in the governor frequency modulation mode;
adjust a threshold for increasing a frequency in the governor frequency modulation mode;
adjust a threshold for reducing a frequency in the governor frequency modulation mode;
adjust a response whether the central processing unit suffers a sudden large load; and
adjust a duration for the central processing unit being at a maximum frequency.

25. The non-transitory computer-readable storage medium according to claim 23, wherein the executable instructions, when executed by an electronic device with a touch-sensitive display, cause the electronic device further to:
perform at least one of the following operations in a case that the normalized value is greater than the preset normalized threshold value:
adjust a sampling period in the governor frequency modulation mode;
adjust a threshold for increasing a frequency in the governor frequency modulation mode;
adjust a threshold for reducing a frequency in the governor frequency modulation mode;
adjust a response whether the central processing unit suffers a sudden large load; and
adjust a duration for the central processing unit being at a maximum frequency.
